(19) United States
(12) Patent Application Publication
(10) Pub. No.: US 2018/0065086 A1
(43) Pub. Date: Mar. 8, 2018

(54) DIESEL OXIDATION CATALYST WITH NOX ADSORBER ACTIVITY

(71) Applicant: Johnson Matthey Public Limited Company, London (GB)

(72) Inventors: Yannick BIDAL, Royston (GB); Andrew CHIFFEY, Royston (GB); Francois MOREAU, Royston (GB); Matthew O'BRIEN, Royston (GB)

(21) Appl. No.: 15/692,324

(22) Filed: Aug. 31, 2017

(30) Foreign Application Priority Data
Sep. 6, 2016 (GB) 1615134.2

(51) Int. Cl. B01D 53/94; B01J 21/12; B01J 21/10; B01J 29/72

(52) U.S. Cl. CPC B01D 53/9413; B01D 53/944; B01J 21/12; B01J 21/10; B01J 29/72; B01D 2255/1023; B01J 2229/64; B01D 2255/9022; B01D 2255/9032; B01D 2258/012; B01J 2204/005; B01J 2229/183; B01D 2255/106

(57) ABSTRACT

An oxidation catalyst for treating an exhaust gas from a diesel engine and an exhaust system comprising the oxidation catalyst are described. The oxidation catalyst comprises: a first region for adsorbing NOₓ, wherein the first region comprises a molecular sieve catalyst, wherein the molecular sieve catalyst comprises a noble metal and a molecular sieve; a second region for oxidising carbon monoxide (CO) and/or hydrocarbons (HCs), wherein the second region comprises palladium (Pd), gold (Au) and a support material; and a substrate having an inlet end and an outlet end.

### CROSS REFERENCE TO RELATED APPLICATIONS

This application claims priority benefit to Great Britain Patent Application No. 1615134.2 filed on Sep. 6, 2016, which is incorporated herein by reference.

### FIELD OF THE INVENTION

The invention relates to an oxidation catalyst for a diesel engine and to an exhaust system for a diesel engine comprising the oxidation catalyst. The invention also relates to methods and uses of the oxidation catalyst for treating an exhaust gas from a diesel engine.

### BACKGROUND TO THE INVENTION

Diesel engines produce an exhaust emission that generally contains at least four classes of pollutant that are legislated against by inter-governmental organisations throughout the world: carbon monoxide (CO), unburned hydrocarbons (HCs), oxides of nitrogen (NOₓ) and particulate matter (PM).

Oxidation catalysts, such as diesel oxidation catalysts (DOCs), are typically used to oxidise carbon monoxide (CO) and hydrocarbons (HCs) in an exhaust gas produced by a diesel engine. Diesel oxidation catalysts can also oxidise some of the nitric oxide (NO) that is present in the exhaust gas to nitrogen dioxide (NO₂).

Oxidation catalysts and other types of emissions control device typically achieve high efficiencies for treating or removing pollutants once they have reached their effective operating temperature. However, these catalysts or devices can be relatively inefficient below their effective operating temperature, such as when the engine has been started from cold (the “cold start” period) or has been idling for a prolonged period. As emissions standards for diesel engines, whether stationary or mobile (e.g. vehicular diesel engines), are being progressively tightened, there is a need to reduce the level of emissions produced during the cold start period.

Exhaust systems for diesel engines may include several emissions control devices. Each emissions control device has a specialised function and is responsible for treating one or more classes of pollutant in the exhaust gas. The performance of an upstream emissions control device can affect the performance of a downstream emissions control device. This is because the exhaust gas from the outlet of the upstream emissions control device is passed into the inlet of the downstream emissions control device. The interaction between each emissions control device in the exhaust system is important to the overall efficiency of the system.

Oxidation catalysts, such as diesel oxidation catalysts, often include platinum arranged in a manner to facilitate the oxidation of nitric oxide (NO) to nitrogen dioxide (NO₂). The NO₂ that is produced can be used to regenerate particulate matter (PM) that has been trapped by, for example, a downstream diesel particulate filter (DPF) or a downstream catalysed soot filter (CSF). It can also be used to ensure optimum performance of a downstream SCR or SCRF™ catalyst because the ratio of NO₂:NO in the exhaust gas produced directly by a diesel engine can be too low for such performance.

Any platinum included in an oxidation catalyst for oxidising nitric oxide (NO) to nitrogen dioxide (NO₂) can also produce nitrous oxide (N₂O) by reduction of NOₓ(Catalysis Today 26 (1995) 185-206). Current legislation for regulating engine emissions does not limit nitrous oxide (N₂O) because it is regulated separately as a greenhouse gas (GHG). Nevertheless, it is desirable for emissions to contain minimal nitrous oxide (N₂O). The US Environmental Protection Agency has stated that the impact of 1 pound of nitrous oxide (N₂O) in warming the atmosphere is over 300 times that of 1 pound of carbon dioxide (CO₂). Nitrous oxide (N₂O) is also an ozone-depleting substance (ODS). It has been estimated that nitrous oxide (N₂O) molecules stay in the atmosphere for about 120 years before being removed or destroyed.

### SUMMARY OF THE INVENTION

The oxidation catalyst of the invention is able to adsorb NOₓ at relatively low exhaust gas temperatures (e.g. less than 200° C.), such as during the cold start period of an engine. At higher exhaust gas temperatures, when a downstream emissions control device is at its effective temperature for treating NOₓ, the adsorbed NOₓ is released from the oxidation catalyst. Advantageously, the oxidation catalyst of the invention can minimise or avoid the production of nitrous oxide (N₂O).

The oxidation catalyst may also be able to adsorb hydrocarbons (HCs) at relatively low temperatures, and then release and oxidise any adsorbed HCs at higher temperatures. The combination of Pd and Au in the oxidation catalyst has good activity toward oxidising carbon monoxide (CO) and hydrocarbons (HCs), particularly at temperatures in the exhaust system when adsorbed hydrocarbons (HCs) have been released.

The invention provides an oxidation catalyst for treating an exhaust gas from a diesel engine, which oxidation catalyst comprises: a first region for adsorbing NOₓ, wherein the first region comprises a molecular sieve catalyst, wherein the molecular sieve catalyst comprises a noble metal and a molecular sieve; a second region for oxidising carbon monoxide (CO) and/or hydrocarbons (HCs), wherein the second region comprises palladium (Pd), gold (Au) and a support material; and a substrate having an inlet end and an outlet end.

To provide good NOₓ storage activity, the oxidation catalyst of the invention has a first region, which is formulated to adsorb NOₓ. The first region has passive NOₓ adsorber (PNA) activity. Passive NOₓ adsorber (PNA) compositions store or adsorb NOₓ at relatively low exhaust gas temperatures, usually by adsorption, and release NOₓ at higher temperatures. The storage mechanism of PNAs is different to lean NOₓ traps (LNTs) [also referred to in the art as NOₓ adsorber catalysts (NACs) or NOₓ storage catalysts (NSCs)], which store NOₓ under “lean” exhaust gas conditions and release NOₓ under “rich” exhaust gas conditions.

The oxidation catalyst of the invention also has a second region, which is formulated to oxidise carbon monoxide (CO) and/or hydrocarbons (HCs) while avoiding or minimising the production of nitrous oxide (N₂O). The second region contains palladium and gold for oxidising carbon monoxide (CO) and hydrocarbons (HCs).

The molecular sieve catalyst of the first region can provide excellent NOₓ storage activity and will store NOₓ up to relatively high temperatures. The first region may release NOₓ when a downstream emissions control device is close to, or has reached, its effective temperature for treating NOₓ.

The invention further provides an exhaust system for a diesel engine. The exhaust system comprises an oxidation catalyst of the invention and an emissions control device.

A further aspect of the invention relates to a vehicle or an apparatus (e.g. a stationary or mobile apparatus). The vehicle or apparatus comprises a diesel engine and either the oxidation catalyst or the exhaust system of the invention.

The invention also relates to several uses and methods.

A first method aspect of the invention provides a method of treating an exhaust gas from a diesel engine. The method comprises either contacting the exhaust gas with an oxidation catalyst of the invention or passing the exhaust gas through an exhaust system of the invention. The expression “treating an exhaust gas” in this context refers to oxidising carbon monoxide (CO), hydrocarbons (HCs) and/or nitric oxide (NO) in an exhaust gas from a diesel engine.

A first use aspect of the invention relates to the use of an oxidation catalyst to treat an exhaust gas from a diesel engine, optionally in combination with an emissions control device. Generally, the oxidation catalyst is used to treat (e.g. oxidise) carbon monoxide (CO) and hydrocarbons (HCs) in an exhaust gas from a diesel engine.

A second use aspect of the invention relates to the use of an oxidation catalyst as a passive NOₓ absorber (PNA) in an exhaust gas from a diesel engine optionally in combination with an emissions control device.

In the first and second use aspects, the oxidation catalyst is an oxidation catalyst in accordance with the invention.

### BRIEF DESCRIPTION OF THE DRAWINGS

FIGS. 1 to 5 are schematic representations of oxidation catalysts of the invention.

FIG. 1 shows an oxidation catalyst comprising a first region (1) and a second region/zone (2) disposed on a substrate (3).

FIG. 2 shows an oxidation catalyst comprising a first region (1) and a second region/zone (2). There is an overlap between the first region (1) and the second region/zone (2). A part of the first region (1) is disposed on the second region/zone (2). Both the first region (1) and the second region/zone (2) are disposed on the substrate (3).

FIG. 3 shows an oxidation catalyst comprising a first region (1) and a second region/zone (2). There is an overlap between the first region (1) and the second region/zone (2). A part of the second region/zone (2) is disposed on the first region (1). Both the first region (1) and the second region/zone (2) are disposed on the substrate (3).

FIG. 4 shows an oxidation catalyst comprising a first layer (1) disposed on a substrate (3). The second layer (2) is disposed on the first layer (1).

FIG. 5 shows an oxidation catalyst comprising a second layer (2) disposed on a substrate (3). The first layer (1) is disposed on the second layer (2).

### DETAILED DESCRIPTION OF THE INVENTION

The oxidation catalyst of the invention comprises a first region and a second region. The first region may comprise, or consists essentially of, a molecular sieve catalyst.

The molecular sieve catalyst comprises a noble metal and a molecular sieve. The molecular sieve catalyst is a passive NOₓ absorber (PNA) catalyst (i.e. it has PNA activity). The molecular sieve catalyst can be prepared according to the method described in WO 2012/166868.

The noble metal is typically selected from the group consisting of palladium (Pd), platinum (Pt), rhodium (Rh), gold (Au), silver (Ag), iridium (Ir), ruthenium (Ru) and mixtures of two or more thereof. Preferably, the noble metal is selected from the group consisting of palladium (Pd), platinum (Pt) and rhodium (Rh). More preferably, the noble metal is selected from palladium (Pd), platinum (Pt) and a mixture thereof.

Generally, it is preferred that the noble metal comprises, or consists of, palladium (Pd) and optionally a second metal selected from the group consisting of platinum (Pt), rhodium (Rh), gold (Au), silver (Ag), iridium (Ir) and ruthenium (Ru). Preferably, the noble metal comprises, or consists of, palladium (Pd) and optionally a second metal selected from the group consisting of platinum (Pt) and rhodium (Rh). Even more preferably, the noble metal comprises, or consists of, palladium (Pd) and optionally platinum (Pt). More preferably, the molecular sieve catalyst comprises palladium as the only noble metal.

When the noble metal comprises, or consists of, palladium (Pd) and a second metal, then the ratio by mass of palladium (Pd) to the second metal is >1:1. More preferably, the ratio by mass of palladium (Pd) to the second metal is >1:1 and the molar ratio of palladium (Pd) to the second metal is >1:1.

The molecular sieve catalyst may further comprise a base metal. Thus, the molecular sieve catalyst may comprise, or consist essentially of, a noble metal, a molecular sieve and optionally a base metal. The molecular sieve contains the noble metal and optionally the base metal.

The base metal may be selected from the group consisting of iron (Fe), copper (Cu), manganese (Mn), chromium (Cr), cobalt (Co), nickel (Ni), zinc (Zn) and tin (Sn), as well as mixtures of two or more thereof. It is preferred that the base metal is selected from the group consisting of iron, copper and cobalt, more preferably iron and copper. Even more preferably, the base metal is iron.

Alternatively, the molecular sieve catalyst may be substantially free of a base metal, such as a base metal selected from the group consisting of iron (Fe), copper (Cu), manganese (Mn), chromium (Cr), cobalt (Co), nickel (Ni), zinc (Zn) and tin (Sn), as well as mixtures of two or more thereof. Thus, the molecular sieve catalyst may not comprise a base metal.

In general, it is preferred that the molecular sieve catalyst does not comprise a base metal.

It may be preferable that the molecular sieve catalyst is substantially free of barium (Ba), more preferably the molecular sieve catalyst is substantially free of an alkaline earth metal. Thus, the molecular sieve catalyst may not comprise barium, preferably the molecular sieve catalyst does not comprise an alkaline earth metal.

The molecular sieve is typically composed of aluminium, silicon, and/or phosphorus. The molecular sieve generally has a three-dimensional arrangement (e.g. framework) of SiO₄, AlO₄, and/or PO₄ that are joined by the sharing of oxygen atoms. The molecular sieve may have an anionic framework. The charge of the anionic framework may be counterbalanced by cations, such as by cations of alkali and/or alkaline earth elements (e.g., Na, K, Mg, Ca, Sr, and Ba), ammonium cations and/or protons.

Typically, the molecular sieve has an aluminosilicate framework, an aluminophosphate framework or a silico-aluminophosphate framework. The molecular sieve may have an aluminosilicate framework or an aluminophosphate framework. It is preferred that the molecular sieve has an aluminosilicate framework or a silico-aluminophosphate framework. More preferably, the molecular sieve has an aluminosilicate framework.

When the molecular sieve has an aluminosilicate framework, then the molecular sieve is preferably a zeolite.

The molecular sieve contains the noble metal. The noble metal is typically supported on the molecular sieve. For example, the noble metal may be loaded onto and supported on the molecular sieve, such as by ion-exchange. Thus, the molecular sieve catalyst may comprise, or consist essentially of, a noble metal and a molecular sieve, wherein the molecular sieve contains the noble metal and wherein the noble metal is loaded onto and/or supported on the molecular sieve by ion exchange.

In general, the molecular sieve may be a metal-substituted molecular sieve (e.g. metal-substituted molecular sieve having an aluminosilicate or an aluminophosphate framework). The metal of the metal-substituted molecular sieve may be the noble metal (e.g. the molecular sieve is a noble metal substituted molecular sieve). Thus, the molecular sieve containing the noble metal may be a noble metal substituted molecular sieve. When the molecular sieve catalyst comprises a base metal, then the molecular sieve may be a noble and base metal-substituted molecular sieve. For the avoidance of doubt, the term “metal-substituted” embraces the term “ion-exchanged”.

The molecular sieve catalyst generally has at least 1% by weight (i.e. of the amount of noble metal of the molecular sieve catalyst) of the noble metal located inside pores of the molecular sieve, preferably at least 5% by weight, more preferably at least 10% by weight, such as at least 25% by weight, even more preferably at least 50% by weight.

The molecular sieve may be selected from a small pore molecular sieve (i.e. a molecular sieve having a maximum ring size of eight tetrahedral atoms), a medium pore molecular sieve (i.e. a molecular sieve having a maximum ring size of ten tetrahedral atoms) and a large pore molecular sieve (i.e. a molecular sieve having a maximum ring size of twelve tetrahedral atoms). More preferably, the molecular sieve is selected from a small pore molecular sieve and a medium pore molecular sieve.

In a first molecular sieve catalyst embodiment, the molecular sieve is a small pore molecular sieve. The small pore molecular sieve preferably has a Framework Type selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG and ZON, as well as a mixture or intergrowth of any two or more thereof. The intergrowth is preferably selected from KFI-SIV, ITE-RTH, AEW-UEI, AEI-CHA, and AEI-SAV. More preferably, the small pore molecular sieve has a Framework Type that is AEI, CHA or an AEI-CHA intergrowth. Even more preferably, the small pore molecular sieve has a Framework Type that is AEI or CHA, particularly AEI.

Preferably, the small pore molecular sieve has an aluminosilicate framework or a silico-aluminophosphate framework. More preferably, the small pore molecular sieve has an aluminosilicate framework (i.e. the molecular sieve is a zeolite), especially when the small pore molecular sieve has a Framework Type that is AEI, CHA or an AEI-CHA intergrowth, particularly AEI or CHA.

In a second molecular sieve catalyst embodiment, the molecular sieve has a Framework Type selected from the group consisting of AEI, MFI, EMT, ERI, MOR, FER, BEA, FAU, CHA, LEV, MWW, CON and EUO, as well as mixtures of any two or more thereof.

In a third molecular sieve catalyst embodiment, the molecular sieve is a medium pore molecular sieve. The medium pore molecular sieve preferably has a Framework Type selected from the group consisting of MFI, FER, MWW and EUO, more preferably MFI.

In a fourth molecular sieve catalyst embodiment, the molecular sieve is a large pore molecular sieve. The large pore molecular sieve preferably has a Framework Type selected from the group consisting of CON, BEA, FAU, MOR and EMT, more preferably BEA.

In each of the first to fourth molecular sieve catalyst embodiments, the molecular sieve preferably has an aluminosilicate framework (e.g. the molecular sieve is a zeolite). Each of the aforementioned three-letter codes represents a framework type in accordance with the “IUPAC Commission on Zeolite Nomenclature” and/or the “Structure Commission of the International Zeolite Association”.

The molecular sieve typically has a silica to alumina molar ratio (SAR) of 10 to 200 (e.g. 10 to 40), such as 10 to 100, more preferably 15 to 80 (e.g. 15 to 30). The SAR generally relates to a molecular having an aluminosilicate framework (e.g. a zeolite) or a silico-aluminophosphate framework, preferably an aluminosilicate framework (e.g. a zeolite).

The molecular sieve catalyst of the first, third and fourth molecular sieve catalyst embodiments (and also for some of the Framework Types of the second molecular sieve catalyst embodiment), particularly when the molecular sieve is a zeolite, may have an infrared spectrum having a characteristic absorption peak in a range of from 750 cm⁻¹ to 1050 cm⁻¹ (in addition to the absorption peaks for the molecular sieve itself). Preferably, the characteristic absorption peak is in the range of from 800 cm⁻¹ to 1000 cm⁻¹, more preferably in the range of from 850 cm⁻¹ to 975 cm⁻¹.

The molecular sieve catalyst of the first molecular sieve catalyst embodiment has been found to have advantageous passive NOₓ adsorber (PNA) activity. The molecular sieve catalyst can be used to store NOₓ when exhaust gas temperatures are relatively cool, such as shortly after start-up of a lean burn engine. NOₓ storage by the molecular sieve catalyst occurs at low temperatures (e.g. less than 200° C.). As the lean burn engine warms up, the exhaust gas temperature increases and the temperature of the molecular sieve catalyst will also increase. The molecular sieve catalyst will release adsorbed NOₓ at these higher temperatures (e.g. 200° C. or above).

It has also been unexpectedly found that the molecular sieve catalyst, particularly the molecular sieve catalyst of the second molecular sieve catalyst embodiment has cold start catalyst activity. Such activity can reduce emissions during the cold start period by adsorbing NOₓ and hydrocarbons (HCs) at relatively low exhaust gas temperatures (e.g. less than 200° C.). Adsorbed NOₓ and/or HCs can be released when the temperature of the molecular sieve catalyst is close to or above the effective temperature of the other catalyst components or emissions control devices for oxidising NO and/or HCs.

Generally, the first region typically comprises a total loading of noble metal (i.e. of the molecular sieve catalyst in the first region) of ≧1 g ft⁻³, preferably >1 g ft⁻³, and more preferably >2 g ft⁻³.

The first region typically comprises a total loading of noble metal (i.e. of the molecular sieve catalyst in the first region) of 1 to 250 g ft⁻³, preferably 5 to 150 g ft⁻³, more preferably 10 to 100 g ft⁻³. The amount of noble metal in the molecular sieve catalyst can affect its NOₓ storage activity.

The first region may comprise a binder. The binder may be refractory oxide. The refractory oxide may be a refractory oxide as described below in relation to a support material in the second region, such as alumina. When the first region comprises a binder, then it is preferred that the binder does not comprise a noble metal (e.g. a noble metal is not supported on the refractory oxide of the binder).

The first region may comprise an oxygen storage material. An oxygen storage material can be used to reduce or prevent the molecular sieve catalyst from becoming deactivated (i.e. deactivated to NOₓ storage), particularly when the molecular sieve catalyst is inadvertently exposed to rich exhaust gas conditions.

Typically, the oxygen storage material comprises, or consists essentially of, an oxide of cerium and/or a manganese compound. It is preferred that the oxygen storage material comprises, or consists essentially of, an oxide of cerium.

The oxide of cerium is preferably ceria (CeO₂).

The oxygen storage material may comprise, or consist essentially of, a mixed or composite oxide of the oxide of cerium, particularly a mixed or composite oxide of ceria.

Typically, the mixed or composite oxide of an oxide of cerium consists essentially of (a) 20 to 95% by weight of the oxide of cerium (e.g. CeO₂) and 5 to 80% by weight of a second oxide, preferably a second oxide selected from the group consisting of zirconia, alumina, lanthanum and a combination of two or more thereof. It may be preferable that the second oxide is zirconia or a combination of zirconia and alumina, particularly when the oxygen storage material comprises an oxide of cerium.

The manganese compound may comprise, or consist of, an oxide of manganese or manganese aluminate. The oxide of manganese may be selected from the group consisting of manganese (II) oxide (MnO), manganese (III) oxide (Mn₂O₃), manganese (II, III) oxide (MnO.Mn₂O₃ [sometimes written as Mn₃O₄]) and manganese (IV) oxide (MnO₂). Manganese aluminate is MnAl₂O₄.

Alternatively, the first region is substantially free of, or does not comprise, an oxygen storage material, such as described above.

The oxidation catalyst of the invention comprises a second region for oxidising carbon monoxide (CO) and/or hydrocarbons (HCs). Typically, the second region is (e.g. is formulated) for oxidising carbon monoxide (CO), hydrocarbons (HCs) and nitric oxide (NO) (i.e. to nitrogen dioxide (NO₂).

The second region comprises, or consists essentially of, palladium, gold and a support material.

The combination of Pd and Au is catalytically active in the oxidation of carbon monoxide and hydrocarbons in “lean” exhaust gas conditions. This combination can also catalytically oxidise nitric oxide (NO) to nitrogen dioxide (NO₂) (e.g. with minimal or no production of nitrous oxide (N₂O)).

For the avoidance of doubt, the first region is different (i.e. different composition) to the second region.

Typically, the palladium is disposed or supported on the support material. The Pd may be disposed directly onto or is directly supported by the support material (e.g. there is no intervening support material between the Pd and the support material). For example, palladium can be dispersed on the support material.

The gold is typically disposed or supported on the support material. The Au may be disposed directly onto or is directly supported by the support material (e.g. there is no intervening support material between the Au and the support material). For example, gold can be dispersed on the support material.

The second region may comprise a palladium-gold alloy. The palladium-gold alloy is preferably a bimetallic palladium-gold alloy.

It is preferred that the second region is substantially free of, or does not comprise, platinum. More preferably, the second region does not comprise one or more of ruthenium (Ru), rhodium (Rh), osmium (Os) or iridium (Ir), especially rhodium.

Generally, the second region comprises a ratio by mass of palladium (Pd) to gold (Au) of 9:1 to 1:9, preferably 5:1 to 1:5, and more preferably 2:1 to 1:2.

It is preferred that the second region comprises a ratio by mass of palladium (Pd) to gold (Au) of ≧1:1 (e.g. 9:1 to 1:1), particularly >1:1 (e.g. 5:1 to 1.1:1).

The second region typically has a total loading of palladium of 5 to 300 g ft⁻³. It is preferred that the second region has a total loading of palladium of 10 to 250 g ft⁻³ (e.g. 75 to 175 g·ft⁻³), more preferably 15 to 200 g ft⁻³ (e.g. 50 to 150 g ft⁻³), still more preferably 20 to 150 g ft⁻³.

The second region may have a total loading of gold of 5 to 300 g ft⁻³. It is preferred that the second region has a total loading of gold of 10 to 250 g ft⁻³ (e.g. 75 to 175 g ft⁻³), more preferably 15 to 200 g ft⁻³ (e.g. 50 to 150 g ft⁻³), still more preferably 20 to 150 g ft⁻³.

Typically, the support material comprises, or consists essentially of, a refractory oxide. Refractory oxides suitable for use as a catalytic component of an oxidation catalyst for a diesel engine are well known in the art.

The refractory oxide is typically selected from the group consisting of alumina, silica, titania, zirconia, ceria and a mixed or composite oxide thereof, such as a mixed or composite oxide of two or more thereof. For example, the refractory oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

The refractory oxide may optionally be doped (e.g. with a dopant). The dopant may be selected from the group consisting of zirconium (Zr), titanium (Ti), silicon (Si), yttrium (Y), lanthanum (La), praseodymium (Pr), samarium (Sm), neodymium (Nd) and an oxide thereof.

It is to be understood that any reference to “doped” in this context refers to a material where the bulk or host lattice of the refractory oxide is substitution doped or interstitially doped with a dopant. In some instances, small amounts of the dopant may be present at a surface of the refractory oxide. However, most of the dopant will generally be present in the body of the refractory oxide.

When the refractory oxide is doped, the total amount of dopant is 0.25 to 5% by weight, preferably 0.5 to 3% by weight (e.g. about 1% by weight) of the refractory oxide.

It is preferred that the refractory oxide comprises, or consists essentially of, alumina, ceria and/or ceria-zirconia. More preferably, the refractory oxide comprises or consists essentially of alumina. Even more preferably, the refractory oxide is alumina.

When the refractory oxide comprises or consists essentially of ceria-zirconia, then the ceria-zirconia may consist essentially of 20 to 95% by weight of ceria and 5 to 80% by weight of zirconia (e.g. 50 to 95% by weight ceria and 5 to 50% by weight zirconia), preferably 35 to 80% by weight of ceria and 20 to 65% by weight zirconia (e.g. 55 to 80% by weight ceria and 20 to 45% by weight zirconia), even more preferably 45 to 75% by weight of ceria and 25 to 55% by weight zirconia.

The second region may comprise a total loading of support material of 0.1 to 4.5 g in⁻³ (e.g. 0.25 to 4.2 g in⁻³), preferably 0.3 to 3.8 g in⁻³, still more preferably 0.5 to 3.0 g in⁻³ (1 to 2.75 g in⁻³ or 0.75 to 1.5 g in⁻³), and even more preferably 0.6 to 2.5 g in⁻³ (e.g. 0.75 to 2.3 g in⁻³).

The second region may further comprise a hydrocarbon adsorbent material.

In general, the hydrocarbon adsorbent material may be a zeolite. The inclusion of a zeolite as a hydrocarbon adsorbent can be beneficial in improving the oxidative performance of Pd and Au toward long chain hydrocarbons. That is because the combination of Pd and Au has excellent oxidative activity toward carbon monoxide (CO), but this combination shows lower activity toward hydrocarbons than, for example, platinum. The inclusion of a hydrocarbon adsorbent, particularly a zeolite, can store hydrocarbon until the combination of Pd and Au becomes more active (e.g. as the temperature increases). The hydrocarbon adsorbent can then release the hydrocarbon when the combination of Pd and Au has better oxidative activity toward it.

It is preferred that the zeolite is a medium pore zeolite (e.g. a zeolite having a maximum ring size of ten tetrahedral atoms) or a large pore zeolite (e.g. a zeolite having a maximum ring size of twelve tetrahedral atoms). It may be preferable that the zeolite is not a small pore zeolite (e.g. a zeolite having a maximum ring size of eight tetrahedral atoms).

Examples of suitable zeolites or types of zeolite include faujasite, clinoptilolite, mordenite, silicalite, ferrierite, zeolite X, zeolite Y, ultrastable zeolite Y, AEI zeolite, ZSM-5 zeolite, ZSM-12 zeolite, ZSM-20 zeolite, ZSM-34 zeolite, CHA zeolite, SSZ-3 zeolite, SAPO-5 zeolite, offretite, a beta zeolite or a copper CHA zeolite. The zeolite is preferably ZSM-5, a beta zeolite or a Y zeolite.

When the hydrocarbon adsorbent is a zeolite, the zeolite is substantially free of a noble metal, such as described above (e.g. platinum (Pt), rhodium (Rh), gold (Au), silver (Ag), iridium (Ir) and ruthenium (Ru)). More preferably, the zeolite does not comprise a noble metal, such as described above.

When the second region comprises a hydrocarbon adsorbent, the total amount of hydrocarbon adsorbent is 0.05 to 3.00 g in⁻³, particularly 0.10 to 2.00 g in⁻³, more particularly 0.2 to 1.0 g in⁻³. For example, the total amount of hydrocarbon adsorbent may be 0.8 to 1.75 g in⁻³, such as 1.0 to 1.5 g in⁻³.

Alternatively, it may be preferable that the second region is substantially free of a hydrocarbon adsorbent material, particularly a zeolite. Thus, the second region may not comprise a hydrocarbon adsorbent material, such as a zeolite.

It may be further preferable that the second region is substantially free of a molecular sieve catalyst, such as the molecular sieve catalyst described herein above. Thus, the second region may not comprise the molecular sieve catalyst.

The first region and/or the second region may be disposed or supported on the substrate.

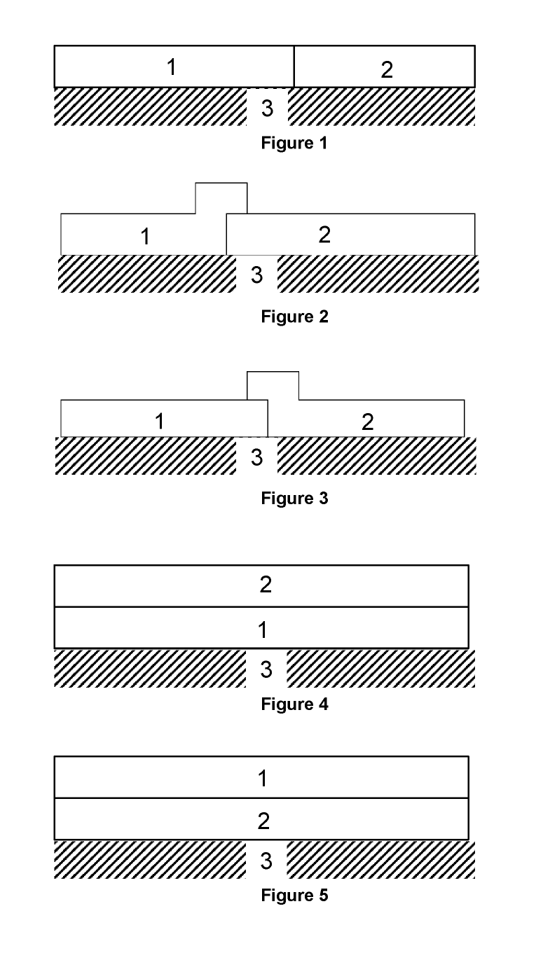

The first region may be disposed directly on to the substrate (i.e. the first region is in contact with a surface of the substrate; see FIGS. 1 to 4). The second region may be:
(a) disposed or supported on the first region (e.g. see FIGS. 2 to 4); and/or
(b) disposed directly on to the substrate [i.e. the second region is in contact with a surface of the substrate] (e.g. see FIGS. 1 to 3); and/or
(c) in contact with the first region [i.e. the second region is adjacent to, or abuts, the first region].

When the second region is disposed directly on to the substrate, then a part or portion of the second region may be in contact with the first region or the first region and the second region may be separated (e.g. by a gap).

When the second region is disposed or supported on the first region, all or part of the second region is preferably disposed directly on to the first region (i.e. the second region is in contact with a surface of the first region). The second region may be a second layer and the first region may be a first layer.

It may be preferable that only a portion or part of the second region is disposed or supported on the first region. Thus, the second region does not completely overlap or cover the first region.

In addition or as an alternative, the second region may be disposed directly on to the substrate (i.e. the second region is in contact with a surface of the substrate; see FIGS. 1 to 3 and 5). The first region may be:
(i) disposed or supported on the second region (e.g. see FIGS. 2, 3 and 5); and/or
(ii) disposed directly on to the substrate [i.e. the first region is in contact with a surface of the substrate] (e.g. see FIGS. 1 to 3); and/or
(iii) in contact with the second region [i.e. the first region is adjacent to, or abuts, the second region].

When the first region is disposed directly on to the substrate, then a part or portion of the first region may be in contact with the second region or the first region and the second region may be separated (e.g. by a gap).

When the first region is disposed or supported on the second region, all or part of the first region is preferably disposed directly on to the second region (i.e. the first region is in contact with a surface of the second region). The first region may be a first layer and the second region may be a second layer.

In general, the first region may be a first layer or a first zone. When the first region is a first layer, then it is preferred that the first layer extends for an entire length (i.e. substantially an entire length) of the substrate, particularly the entire length of the channels of a substrate monolith. When the first region is a first zone, then typically the first zone has a length of 10 to 90% of the length of the substrate (e.g. 10 to 45%), preferably 15 to 75% of the length of the substrate (e.g. 15 to 40%), more preferably 20 to 70% (e.g. 30 to 65%, such as 25 to 45%) of the length of the substrate, still more preferably 25 to 65% (e.g. 35 to 50%).

The second region may generally be a second layer or a second zone. When the second region is a second layer, then it is preferred that the second layer extends for an entire length (i.e. substantially an entire length) of the substrate, particularly the entire length of the channels of a substrate monolith. When the second region is a second zone, then typically the second zone has a length of 10 to 90% of the length of the substrate (e.g. 10 to 45%), preferably 15 to 75% of the length of the substrate (e.g. 15 to 40%), more preferably 20 to 70% (e.g. 30 to 65%, such as 25 to 45%) of the length of the substrate, still more preferably 25 to 65% (e.g. 35 to 50%).

In a first oxidation catalyst embodiment, the first region is arranged to contact the exhaust gas at or near the outlet end of the substrate and after contact of the exhaust gas with the second region. Such an arrangement may be advantageous when the first region has a low light off temperature for CO and/or HCs, and can be used to generate an exotherm.

There are several oxidation catalyst arrangements that facilitate the contact of the exhaust gas with the first region at an outlet end of the substrate and after the exhaust gas has been in contact with the second region. The first region is arranged or oriented to contact exhaust after it has contacted the second region when it has any one of the first to fourth oxidation catalyst arrangements.

Typically, the second region is arranged or oriented to contact exhaust gas before the first region. Thus, the second region may be arranged to contact exhaust gas as it enters the oxidation catalyst and the first region may be arranged to contact the exhaust gas as it leaves the oxidation catalyst. The zoned arrangements of the first oxidation catalyst arrangement and the third oxidation catalyst arrangement are particularly advantageous in this respect.

In a first oxidation catalyst arrangement, the second region is disposed or supported upstream of the first zone. Preferably, the first region is a first zone disposed at or near an outlet end of the substrate and the second region is a second zone disposed at or near an inlet end of the substrate.

In a second oxidation catalyst arrangement, the second region is a second layer and the first region is a first zone. The first zone is disposed on the second layer at or near an outlet end of the substrate.

In a third oxidation catalyst arrangement, the second region is a second zone and the first region is a first layer. The second zone is disposed on the first layer at or near an inlet end of the substrate.

In a fourth oxidation catalyst arrangement, the second region is a second layer and the first region is a first layer. The second layer is disposed on the first layer.

In a second oxidation catalyst embodiment, the second region is arranged to contact the exhaust gas at or near the outlet end of the substrate and after contact of the exhaust gas with the first region.

There are several oxidation catalyst arrangements that facilitate the contact of the exhaust gas with the second region at an outlet end of the substrate and after the exhaust gas has been in contact with the first region. The second region is arranged or oriented to contact exhaust after it has contacted the first region when it has any one of the fifth to eighth oxidation catalyst arrangements.

Typically, the first region is arranged or oriented to contact exhaust gas before the second region. Thus, the first region may be arranged to contact exhaust gas as it enters the oxidation catalyst and the second region may be arranged to contact the exhaust gas as it leaves the oxidation catalyst. The zoned arrangement of the fifth oxidation catalyst arrangement is particularly advantageous in this respect.

In a fifth oxidation catalyst arrangement, the first region is disposed or supported upstream of the second zone. Preferably, the second region is a second zone disposed at or near an outlet end of the substrate and the first region is a first zone disposed at or near an inlet end of the substrate.

In a sixth oxidation catalyst arrangement, the first region is a first layer and the second region is a second zone. The second zone is disposed on the first layer at or near an outlet end of the substrate.

In a seventh oxidation catalyst arrangement, the first region is a first zone and the second region is a second layer. The first zone is disposed on the second layer at or near an inlet end of the substrate.

In an eighth oxidation catalyst arrangement, the first region is a first layer and the second region is a second layer. The first layer is disposed on the second layer.

In the first and fifth oxidation catalyst arrangements, the first zone may adjoin the second zone. Preferably, the first zone is contact with the second zone. When the first zone adjoins the second zone or the first zone is in contact with the second zone, then the first zone and the second zone may be disposed or supported on the substrate as a layer (e.g. a single layer). Thus, a layer (e.g. a single) may be formed on the substrate when the first and second zones adjoin or are in contact with one another. Such an arrangement may avoid problems with back pressure.

The first zone may be separate from the second zone. There may be a gap (e.g. a space) between the first zone and the second zone.

The first zone may overlap the second zone. Thus, an end portion or part of the first zone may be disposed or supported on the second zone. The first zone may completely or partly overlap the second zone. When the first zone overlaps the second zone, it is preferred that first zone only partly overlaps the second zone (i.e. the top, outermost surface of the second zone is not completely covered by the first zone).

Alternatively, the second zone may overlap the first zone. Thus, an end portion or part of the second zone may be disposed or supported on the first zone. The second zone generally only partly overlaps the first zone.

It is preferred that the first zone and the second zone do not substantially overlap.

In the second, third, sixth and seventh oxidation catalyst arrangements, the zone (i.e. the first or second zone) is typically disposed or supported on the layer (i.e. the first or second layer). Preferably the zone is disposed directly on to the layer (i.e. the zone is in contact with a surface of the layer).

When the zone (i.e. the first or second zone) is disposed or supported on the layer (i.e. the first or second layer), it is preferred that the entire length of the zone is disposed or supported on the layer. The length of the zone is less than the length of the layer.

In general, it is possible that both the first region and the second region are not directly disposed on the substrate (i.e. neither the first region nor the second region is in contact with a surface of the substrate).

The oxidation catalyst of the invention may consist of the first region, the second region and a substrate.

Alternatively, the oxidation catalyst may further comprise a third region. The third region typically comprises, or consists essentially of, platinum and a support material. For the avoidance of doubt, the third region is substantially free of, or does not comprise, gold.

When the oxidation catalyst comprises a third region, then at least one of the first region and the second region may be disposed or supported on the third region. It is preferred that both the first region and the second region are disposed or supported on the third region.

The third region may be disposed directly on to the substrate (i.e. the third region is in contact with a surface of the substrate).

The third region is preferably a third layer or a third zone. More preferably, the third region is a third layer.

When the third region is a third layer, then it is preferred that the third layer extends for an entire length (i.e. substantially an entire length) of the substrate, particularly the entire length of the channels of a substrate monolith.

When the third region is a third zone, then typically the third zone has a length of 50 to 95% of the length of the substrate, preferably 60 to 90% of the length of the substrate (e.g. 75 to 90%).

In a third oxidation catalyst embodiment, the oxidation catalyst comprises a third region, preferably disposed directly on to the substrate.

The third oxidation catalyst embodiment relates to arrangements that facilitate (i) contact of the exhaust gas with the third region after it has contacted at least one of the first region and the second region and (ii) contact of the exhaust gas with at least one of the first region and the second region after the exhaust gas has contacted the third region. This to minimise or avoid the formation of nitrous oxide (N₂O).

In a ninth oxidation catalyst arrangement, the second region is disposed or supported upstream of the first zone. Preferably, the first region is a first zone disposed at or near an outlet end of the substrate and the second region is a second zone disposed at or near an inlet end of the substrate. More preferably, the first zone is disposed on the third region and the second zone is disposed on the third region. The third region is preferably a third layer.

In a tenth oxidation catalyst arrangement, the second region is a second layer and the first region is a first zone. The first zone is disposed on the second layer at or near an inlet end or an outlet end of the substrate, preferably an outlet end of the substrate. The second layer is disposed on the third region. The third region is preferably a third layer.

In an eleventh oxidation catalyst arrangement, the second region is a second layer and the first region is a first layer. The second layer is disposed on the first layer. The first layer is disposed on the third region, which is preferably a third layer.

In a twelfth oxidation catalyst arrangement, the first region is disposed or supported upstream of the second zone. Preferably, the second region is a second zone disposed at or near an outlet end of the substrate and the first region is a first zone disposed at or near an inlet end of the substrate. More preferably, the first zone is disposed on the third region and the second zone is disposed on the third region. The third region is preferably a third layer.

In a thirteenth oxidation catalyst arrangement, the first region is a first layer and the second region is a second zone. The second zone is disposed on the first layer at or near an inlet end or an outlet end of the substrate, preferably an outlet end of the substrate. The first layer is disposed on the third region. The third region is preferably a third layer.

In a fourteenth oxidation catalyst arrangement, the first region is a first layer and the second region is a second layer. The first layer is disposed on the second layer. The second layer is disposed on the third region, which is preferably a third layer.

In a fifteenth oxidation catalyst arrangement, the first region is a first layer and the second region is a second zone. The second zone is disposed on the first layer at or near an inlet end or an outlet end of the substrate, preferably an inlet end of the substrate.

The third region is a third zone disposed on the first layer. The third zone is disposed on the first layer at or near an inlet end or an outlet end of the substrate, preferably an outlet end of the substrate (e.g. downstream of the second zone).

In a sixteenth oxidation catalyst arrangement, the first region is a first zone and the second region is a second layer. The first zone is disposed on the second layer at or near an inlet end or an outlet end of the substrate, preferably an inlet end of the substrate.

The third region is a third zone disposed on the second layer. The third zone is disposed on the first layer at or near an inlet end or an outlet end of the substrate, preferably an outlet end of the substrate (e.g. downstream of the first zone).

In the ninth and twelfth oxidation catalyst arrangements, the first zone may adjoin the second zone. Preferably, the first zone is contact with the second zone. When the first zone adjoins the second zone or the first zone is in contact with the second zone, then the first zone and the second zone may be disposed or supported on the third region as a layer (e.g. a single layer). Thus, a layer (e.g. a single) may be formed on the third region when the first and second zones adjoin or are in contact with one another.

The first zone may be separate from the second zone. There may be a gap (e.g. a space) between the first zone and the second zone.

The first zone may overlap the second zone. Thus, an end portion or part of the first zone may be disposed or supported on the second zone. The first zone may completely or partly overlap the second zone. When the first zone overlaps the second zone, it is preferred that first zone only partly overlaps the second zone (i.e. the top, outermost surface of the second zone is not completely covered by the first zone).

Alternatively, the second zone may overlap the first zone. Thus, an end portion or part of the second zone may be disposed or supported on the first zone. The second zone generally only partly overlaps the first zone.

It is preferred that the first zone and the second zone do not substantially overlap.

In the tenth and thirteenth oxidation catalyst arrangements, the zone (i.e. the first or second zone) is typically disposed or supported on the layer (i.e. the first or second layer). Preferably the zone is disposed directly on to the layer (i.e. the zone is in contact with a surface of the layer).

When the zone (i.e. the first or second zone) is disposed or supported on the layer (i.e. the first or second layer), it is preferred that the entire length of the zone is disposed or supported on the layer. The length of the zone is less than the length of the layer.

In the fifteenth oxidation catalyst arrangement, the third zone may adjoin the second zone. Preferably, the third zone is contact with the second zone. When the third zone adjoins the second zone or the third zone is in contact with the second zone, then the third zone and the second zone may be disposed or supported on the first region as a layer (e.g. a single layer). Thus, a layer (e.g. a single) may be formed on the first region when the third and second zones adjoin or are in contact with one another.

In the sixteenth oxidation catalyst arrangement, the third zone may adjoin the first zone. Preferably, the third zone is contact with the first zone. When the third zone adjoins the first zone or the third zone is in contact with the first zone, then the third zone and the first zone may be disposed or supported on the second region as a layer (e.g. a single layer). Thus, a layer (e.g. a single) may be formed on the second region when the third and first zones adjoin or are in contact with one another.

In the fifteenth and sixteenth oxidation catalyst arrangements, the third zone may be separate from the second or first zone. There may be a gap (e.g. a space) between the third zone and the second or first zone.

The third zone may overlap the second or first zone. Thus, an end portion or part of the third zone may be disposed or supported on the second or first zone. The third zone may completely or partly overlap the second or first zone. When the third zone overlaps the second or first zone, it is preferred that the third zone only partly overlaps the second or first zone (i.e. the top, outermost surface of the second or first zone is not completely covered by the third zone).

Generally, the third region comprises a support material. The support material of the third region is referred to herein as the “third support material”.

The platinum (Pt) is typically disposed or supported on the third support material. The platinum may be disposed directly onto or is directly supported by the third support material (e.g. there is no intervening support material between the platinum and the third support material). For example, platinum can be dispersed on the third support material.

The third region may further comprise palladium, such as palladium disposed or supported on the third support material. When the third region comprises palladium, then the ratio by mass of platinum to palladium in the third region is preferably 2:1 (e.g. Pt:Pd 1:0 to 2:1), more preferably 4:1 (e.g. Pt:Pd 1:0 to 4:1).

It is generally preferred that the third region is substantially free of palladium, particularly substantially free of palladium (Pd) disposed or supported on the third support material.

More preferably, the third region does not comprise palladium, particularly palladium disposed or supported on the third support material.

Generally, the third region comprises platinum (Pt) as the only platinum group metal. The third region preferably does not comprise one or more of ruthenium (Ru), rhodium (Rh), palladium (Pd), osmium (Os) or iridium (Ir).

The third region typically has a total loading of platinum of 5 to 150 g ft⁻³. It is preferred that the third region has a total loading of platinum of 10 to 100 g ft⁻³ (e.g. 15 to 50 g ft⁻³), more preferably 15 to 75 g ft⁻³. The third region typically contains a relatively low loading of platinum to avoid the potential formation of N₂O.

The third region may comprise, or consist essentially of, platinum (Pt), manganese or an oxide thereof, and the third support material.

The manganese or an oxide thereof is typically supported on the third support material. More preferably, the manganese or an oxide thereof is disposed directly onto or is directly supported by the third support material. Manganese or an oxide thereof is typically supported on the third support material by being dispersed over a surface of the third support material, more preferably by being dispersed over, fixed onto a surface of and/or impregnated within the third support material.

Typically, the third region comprises a ratio by mass of Mn:Pt of 5:1, more preferably <5:1.

In general, the third region comprises a ratio by mass of Mn:Pt of 0.5:1, more preferably >0.5:1.

The third region may comprise a ratio by mass of manganese (Mn) to platinum (Pt) of 5:1 to 0.5:1 (e.g. 5:1 to 2:3), preferably 4.5:1 to 1:1 (e.g. 4:1 to 1.1:1), more preferably 4:1 to 1.5:1.

Generally, the third support material comprises, or consists essentially of, a refractory oxide. The refractory oxide comprises, or consists essentially of, alumina, silica, titania, zirconia or ceria, or a mixed or composite oxide thereof, such as a mixed or composite oxide of two or more thereof. For example, the mixed or composite oxide may be selected from the group consisting of alumina, silica, titania, zirconia, ceria, silica-alumina, titania-alumina, zirconia-alumina, ceria-alumina, titania-silica, zirconia-silica, zirconia-titania, ceria-zirconia and alumina-magnesium oxide.

It is preferred that the refractory oxide is selected from alumina, silica-alumina and a mixture of alumina and ceria. Even more preferably, the refractory oxide is selected from alumina and silica-alumina.

When the refractory oxide is a mixed or composite oxide of silica-alumina, then preferably the refractory oxide comprises 0.5 to 45% by weight of silica (i.e. 55 to 99.5% by weight of alumina), preferably 1 to 40% by weight of silica, more preferably 1.5 to 30% by weight of silica (e.g. 1.5 to 10% by weight of silica), particularly 2.5 to 25% by weight of silica, more particularly 3.5 to 20% by weight of silica (e.g. 5 to 20% by weight of silica), even more preferably 4.5 to 15% by weight of silica.

When the refractory oxide is a mixed or composite oxide of alumina and ceria, then preferably the refractory oxide comprises at least 50 to 99% by weight of alumina, more preferably 70 to 95% by weight of alumina, even more preferably 75 to 90% by weight of alumina.

The refractory oxide may optionally be doped (e.g. with a dopant). The dopant may comprise, or consist essentially of, an element selected from the group consisting of cerium (Ce), zirconium (Zr), titanium (Ti), silicon (Si), yttrium (Y), lanthanum (La), praseodymium (Pr), samarium (Sm), neodymium (Nd) and an oxide thereof.

When the refractory oxide is doped, the total amount of dopant is 0.25 to 5% by weight, preferably 0.5 to 3% by weight (e.g. about 1% by weight).

It may be preferable that the refractory oxide is not doped (e.g. with a dopant).

When the refractory oxide comprises, or consists essentially of, alumina, then the alumina may optionally be doped (e.g. with a dopant). The dopant may comprise, or consist essentially, of silicon (Si) or an oxide thereof.

When the alumina is doped with a dopant comprising silicon or an oxide thereof, then preferably the alumina is doped with silica. The alumina is preferably doped with silica in a total amount of 0.5 to 45% by weight (i.e. % by weight of the alumina), preferably 1 to 40% by weight, more preferably 1.5 to 30% by weight (e.g. 1.5 to 10% by weight), particularly 2.5 to 25% by weight, more particularly 3.5 to 20% by weight (e.g. 5 to 20% by weight), even more preferably 4.5 to 15% by weight.

The third region may further comprise a hydrocarbon adsorbent material, such as a zeolite as hereinabove defined. The hydrocarbon adsorbent material is preferably a zeolite.

It is preferred that the third region does not comprise a molecular sieve catalyst, such as described above.

Substrates for supporting oxidation catalysts for treating an exhaust gas from a diesel engine are well known in the art. Methods of making washcoats and applying washcoats onto a substrate are also known in the art (see, for example, our WO 99/47260, WO 2007/077462 and WO 2011/080525).

The substrate typically has a plurality of channels (e.g. for the exhaust gas to flow through). Generally, the substrate is a ceramic material or a metallic material.

It is preferred that the substrate is made or composed of cordierite (SiO₂—Al₂O₃—MgO), silicon carbide (SiC), Fe—Cr—Al alloy, Ni—Cr—Al alloy, or a stainless steel alloy.

Typically, the substrate is a monolith (also referred to herein as a substrate monolith). Such monoliths are well-known in the art.

The substrate monolith may be a flow-through monolith. Alternatively, the substrate may be a filtering monolith.

A flow-through monolith typically comprises a honeycomb monolith (e.g. a metal or ceramic honeycomb monolith) having a plurality of channels extending therethrough, which channels are open at both ends. When the substrate is a flow-through monolith, then the oxidation catalyst of the invention is typically a diesel oxidation catalyst (DOC) or is for use as a diesel oxidation catalyst (DOC).

A filtering monolith generally comprises a plurality of inlet channels and a plurality of outlet channels, wherein the inlet channels are open at an upstream end (i.e. exhaust gas inlet side) and are plugged or sealed at a downstream end (i.e. exhaust gas outlet side), the outlet channels are plugged or sealed at an upstream end and are open at a downstream end, and wherein each inlet channel is separated from an outlet channel by a porous structure. When the substrate is a filtering monolith, then the oxidation catalyst of the invention is typically a catalysed soot filter (CSF) or is for use as a catalysed soot filter (CSF).

When the monolith is a filtering monolith, it is preferred that the filtering monolith is a wall-flow filter. In a wall-flow filter, each inlet channel is alternately separated from an outlet channel by a wall of the porous structure and vice versa. It is preferred that the inlet channels and the outlet channels are arranged in a honeycomb arrangement. When there is a honeycomb arrangement, it is preferred that the channels vertically and laterally adjacent to an inlet channel are plugged at an upstream end and vice versa (i.e. the channels vertically and laterally adjacent to an outlet channel are plugged at a downstream end). When viewed from either end, the alternately plugged and open ends of the channels take on the appearance of a chessboard.

In principle, the substrate may be of any shape or size. However, the shape and size of the substrate is usually selected to optimise exposure of the catalytically active materials in the catalyst to the exhaust gas. The substrate may, for example, have a tubular, fibrous or particulate form. Examples of suitable supporting substrates include a substrate of the monolithic honeycomb cordierite type, a substrate of the monolithic honeycomb SiC type, a substrate of the layered fibre or knitted fabric type, a substrate of the foam type, a substrate of the crossflow type, a substrate of the metal wire mesh type, a substrate of the metal porous body type and a substrate of the ceramic particle type.

The substrate may be an electrically heatable substrate (i.e. the electrically heatable substrate is an electrically heating substrate, in use). When the substrate is an electrically heatable substrate, the oxidation catalyst of the invention comprises an electrical power connection, preferably at least two electrical power connections, more preferably only two electrical power connections. Each electrical power connection may be electrically connected to the electrically heatable substrate and an electrical power source. The oxidation catalyst can be heated by Joule heating, where an electric current through a resistor converts electrical energy into heat energy.

The electrically heatable substrate can be used to release any stored NOₓ from the first region. Thus, when the electrically heatable substrate is switched on, the oxidation catalyst will be heated and the temperature of the first region can be brought up to its NOₓ release temperature. Examples of suitable electrically heatable substrates are described in U.S. Pat. No. 4,300,956, U.S. Pat. No. 5,146,743 and U.S. Pat. No. 6,513,324.

In general, the electrically heatable substrate comprises a metal. The metal may be electrically connected to the electrical power connection or electrical power connections.

Typically, the electrically heatable substrate is an electrically heatable honeycomb substrate. The electrically heatable substrate may be an electrically heating honeycomb substrate, in use.

The electrically heatable substrate may comprise an electrically heatable substrate monolith (e.g. a metal monolith). The monolith may comprise a corrugated metal sheet or foil. The corrugated metal sheet or foil may be rolled, wound or stacked. When the corrugated metal sheet is rolled or wound, then it may be rolled or wound into a coil, a spiral shape or a concentric pattern.

The metal of the electrically heatable substrate, the metal monolith and/or the corrugated metal sheet or foil may comprise an aluminium ferritic steel, such as Fecralloy™.

In general, the oxidation catalyst of the invention is for use as a diesel oxidation catalyst (DOC) or a catalysed soot filter (CSF). In practice, catalyst formulations employed in DOCs and CSFs are similar. Generally, a principle difference between a DOC and a CSF is the substrate onto which the catalyst formulation is coated and the total amount of platinum, palladium and any other catalytically active metals that are coated onto the substrate.

The invention also provides an exhaust system comprising the oxidation catalyst and an emissions control device. Examples of an emissions control device include a diesel particulate filter (DPF), a lean NOₓ trap (LNT), a lean NOₓ catalyst (LNC), a selective catalytic reduction (SCR) catalyst, a diesel oxidation catalyst (DOC), a catalysed soot filter (CSF), a selective catalytic reduction filter (SCRF™) catalyst, an ammonia slip catalyst (ASC) and combinations of two or more thereof. Such emissions control devices are all well known in the art.

Some of the aforementioned emissions control devices have filtering substrates. An emissions control device having a filtering substrate may be selected from the group consisting of a diesel particulate filter (DPF), a catalysed soot filter (CSF), and a selective catalytic reduction filter (SCRF™) catalyst.

It is preferred that the exhaust system comprises an emissions control device selected from the group consisting of a lean NOₓ trap (LNT), an ammonia slip catalyst (ASC), diesel particulate filter (DPF), a selective catalytic reduction (SCR) catalyst, a catalysed soot filter (CSF), a selective catalytic reduction filter (SCRF™) catalyst, and combinations of two or more thereof. More preferably, the emissions control device is selected from the group consisting of a diesel particulate filter (DPF), a selective catalytic reduction (SCR) catalyst, a catalysed soot filter (CSF), a selective catalytic reduction filter (SCRF™) catalyst, and combinations of two or more thereof. Even more preferably, the emissions control device is a selective catalytic reduction (SCR) catalyst or a selective catalytic reduction filter (SCRF™) catalyst.

When the exhaust system of the invention comprises an SCR catalyst or an SCRF™ catalyst, then the exhaust system may further comprise an injector for injecting a nitrogenous reductant, such as ammonia, or an ammonia precursor, such as urea or ammonium formate, preferably urea, into exhaust gas downstream of the oxidation catalyst and upstream of the SCR catalyst or the SCRF™ catalyst. Such an injector may be fluidly linked to a source (e.g. a tank) of a nitrogenous reductant precursor. Valve-controlled dosing of the precursor into the exhaust gas may be regulated by suitably programmed engine management means and closed loop or open loop feedback provided by sensors monitoring the composition of the exhaust gas. Ammonia can also be generated by heating ammonium carbamate (a solid) and the ammonia generated can be injected into the exhaust gas.

Alternatively or in addition to the injector, ammonia can be generated in situ (e.g. during rich regeneration of a LNT disposed upstream of the SCR catalyst or the SCRF™ catalyst). Thus, the exhaust system may further comprise an engine management means for enriching the exhaust gas with hydrocarbons.

The SCR catalyst or the SCRF™ catalyst may comprise a metal selected from the group consisting of at least one of Cu, Hf, La, Au, In, V, lanthanides and Group VIII transition metals (e.g. Fe), wherein the metal is supported on a refractory oxide or molecular sieve. The metal is preferably selected from Ce, Fe, Cu and combinations of any two or more thereof, more preferably the metal is Fe or Cu.

The refractory oxide for the SCR catalyst or the SCRF™ catalyst may be selected from the group consisting of Al₂O₃, TiO₂, CeO₂, SiO₂, ZrO₂ and mixed oxides containing two or more thereof. The non-zeolite catalyst can also include tungsten oxide (e.g. V₂O₅/WO₃/TiO₂, WOₓ/CeZrO₂, WOₓ/ZrO₂ or Fe/WOₓ/ZrO₂).

It is particularly preferred when an SCR catalyst, an SCRF™ catalyst or a washcoat thereof comprises at least one molecular sieve, such as an aluminosilicate zeolite or a SAPO. The at least one molecular sieve can be a small, a medium or a large pore molecular sieve. By “small pore molecular sieve” herein we mean molecular sieves containing a maximum ring size of 8, such as CHA; by “medium pore molecular sieve” herein we mean a molecular sieve containing a maximum ring size of 10, such as ZSM-5; and by “large pore molecular sieve” herein we mean a molecular sieve having a maximum ring size of 12, such as beta. Small pore molecular sieves are potentially advantageous for use in SCR catalysts.

In the exhaust system of the invention, preferred molecular sieves for an SCR catalyst or an SCRF™ catalyst are synthetic aluminosilicate zeolite molecular sieves selected from the group consisting of AEI, ZSM-5, ZSM-20, ERI including ZSM-34, mordenite, ferrierite, BEA including Beta, Y, CHA, LEV including Nu-3, MCM-22 and EU-1, preferably AEI or CHA, and having a silica-to-alumina ratio of about 10 to about 50, such as about 15 to about 40.

In a first exhaust system embodiment, the exhaust system comprises the oxidation catalyst of the invention, preferably as a DOC, and a catalysed soot filter (CSF). Such an arrangement may be called a DOC/CSF. The oxidation catalyst is typically followed by (e.g. is upstream of) the catalysed soot filter (CSF). Thus, for example, an outlet of the oxidation catalyst is connected to an inlet of the catalysed soot filter.

In a second exhaust system embodiment, the exhaust system comprises a diesel oxidation catalyst and the oxidation catalyst of the invention, preferably as a catalysed soot filter (CSF). This arrangement may also be called a DOC/CSF arrangement. Typically, the diesel oxidation catalyst (DOC) is followed by (e.g. is upstream of) the oxidation catalyst of the invention. Thus, an outlet of the diesel oxidation catalyst is connected to an inlet of the oxidation catalyst of the invention.

A third exhaust system embodiment relates to an exhaust system comprising the oxidation catalyst of the invention, preferably as a DOC, a catalysed soot filter (CSF) and a selective catalytic reduction (SCR) catalyst. Such an arrangement may be called a DOC/CSF/SCR and is a preferred exhaust system for a light-duty diesel vehicle. The oxidation catalyst is typically followed by (e.g. is upstream of) the catalysed soot filter (CSF). The catalysed soot filter is typically followed by (e.g. is upstream of) the selective catalytic reduction (SCR) catalyst. A nitrogenous reductant injector may be arranged between the catalysed soot filter (CSF) and the selective catalytic reduction (SCR) catalyst. Thus, the catalysed soot filter (CSF) may be followed by (e.g. is upstream of) a nitrogenous reductant injector, and the nitrogenous reductant injector may be followed by (e.g. is upstream of) the selective catalytic reduction (SCR) catalyst.

A fourth exhaust system embodiment relates to an exhaust system comprising a diesel oxidation catalyst (DOC), the oxidation catalyst of the invention, preferably as a catalysed soot filter (CSF), and a selective catalytic reduction (SCR) catalyst. This is also a DOC/CSF/SCR arrangement. The diesel oxidation catalyst (DOC) is typically followed by (e.g. is upstream of) the oxidation catalyst of the invention. The oxidation catalyst of the invention is typically followed by (e.g. is upstream of) the selective catalytic reduction (SCR) catalyst. A nitrogenous reductant injector may be arranged between the oxidation catalyst and the selective catalytic reduction (SCR) catalyst. Thus, the oxidation catalyst may be followed by (e.g. is upstream of) a nitrogenous reductant injector, and the nitrogenous reductant injector may be followed by (e.g. is upstream of) the selective catalytic reduction (SCR) catalyst.

In a fifth exhaust system embodiment, the exhaust system comprises the oxidation catalyst of the invention, preferably as a DOC, a selective catalytic reduction (SCR) catalyst and either a catalysed soot filter (CSF) or a diesel particulate filter (DPF). The arrangement is either a DOC/SCR/CSF or a DOC/SCR/DPF.

In the fifth exhaust system embodiment, the oxidation catalyst of the invention is typically followed by (e.g. is upstream of) the selective catalytic reduction (SCR) catalyst. A nitrogenous reductant injector may be arranged between the oxidation catalyst and the selective catalytic reduction (SCR) catalyst. Thus, the oxidation catalyst may be followed by (e.g. is upstream of) a nitrogenous reductant injector, and the nitrogenous reductant injector may be followed by (e.g. is upstream of) the selective catalytic reduction (SCR) catalyst. The selective catalytic reduction (SCR) catalyst are followed by (e.g. are upstream of) the catalysed soot filter (CSF) or the diesel particulate filter (DPF).

A sixth exhaust system embodiment comprises the oxidation catalyst of the invention, preferably as a DOC, and a selective catalytic reduction filter (SCRF™) catalyst. Such an arrangement may be called a DOC/SCRF™. The oxidation catalyst of the invention is typically followed by (e.g. is upstream of) the selective catalytic reduction filter (SCRF™) catalyst. A nitrogenous reductant injector may be arranged between the oxidation catalyst and the selective catalytic reduction filter (SCRF™) catalyst. Thus, the oxidation catalyst may be followed by (e.g. is upstream of) a nitrogenous reductant injector, and the nitrogenous reductant injector may be followed by (e.g. is upstream of) the selective catalytic reduction filter (SCRF™) catalyst.

In each of the third to sixth exhaust system embodiments described hereinabove, an ASC catalyst can be disposed downstream from the SCR catalyst or the SCRF™ catalyst (i.e. as a separate substrate monolith), or more preferably a zone on a downstream or trailing end of the substrate monolith comprising the SCR catalyst can be used as a support for the ASC.

The exhaust system of the invention (including the first to the sixth exhaust system embodiments) may further comprise means for introducing hydrocarbon (e.g. fuel) into the exhaust gas. The means for introducing hydrocarbon into the exhaust gas may be a hydrocarbon injector. When the exhaust system comprises a hydrocarbon injector, it is preferred that the hydrocarbon injector is downstream of the oxidation catalyst of the invention.

In general, it is preferable to avoid exposing the oxidation catalyst of the invention to a rich exhaust gas composition. The activity of the molecular sieve catalyst can be degraded by exposure to a rich exhaust gas composition.

It may be preferable that the exhaust system of the invention does not comprise a lean NOₓ trap (LNT), particularly a lean NOₓ trap (LNT) upstream of the oxidation catalyst, such as directly upstream of the oxidation catalyst (e.g. without an intervening emissions control device).

The NOₓ content of an exhaust gas directly from a diesel engine depends on a number of factors, such as the mode of operation of the engine, the temperature of the engine and the speed at which the engine is run. However, it is common for an engine to produce an exhaust gas where NOₓ content is 85 to 95% (by volume) nitric oxide (NO) and 5 to 15% (by volume) nitrogen dioxide (NO₂). The NO:NO₂ ratio is typically from 19:1 to 17:3. However, it is generally favourable for the NO₂ content to be much higher for selective catalytic reduction (SCR) catalysts to reduce NOₓ or to regenerate an emissions control device having a filtering substrate by burning off particulate matter. The PNA activity of the oxidation catalyst can be used to modulate the NOₓ content of an exhaust gas from a compression ignition engine.

The PNA activity of the oxidation catalyst of the present invention allows NOₓ, particularly NOₓ to be stored at low exhaust temperatures. At higher exhaust gas temperatures, the oxidation catalyst is able to oxidise NO to NO₂. It is therefore advantageous to combine the oxidation catalyst of the invention with certain types of emissions control devices as part of an exhaust system.

Another aspect of the invention relates to a vehicle or an apparatus. The vehicle or apparatus comprises a diesel engine. The diesel engine may be a homogeneous charge compression ignition (HCCI) engine, a pre-mixed charge compression ignition (PCCI) engine or a low temperature combustion (LTC) engine. It is preferred that the diesel engine is a conventional (i.e. traditional) diesel engine.

The vehicle may be a light-duty diesel vehicle (LDV), such as defined in US or European legislation. A light-duty diesel vehicle typically has a weight of <2840 kg, more preferably a weight of <2610 kg.

In the US, a light-duty diesel vehicle (LDV) refers to a diesel vehicle having a gross weight of ≦8,500 pounds (US lbs). In Europe, the term light-duty diesel vehicle (LDV) refers to (i) passenger vehicles comprising no more than eight seats in addition to the driver's seat and having a maximum mass not exceeding 5 tonnes, and (ii) vehicles for the carriage of goods having a maximum mass not exceeding 12 tonnes.

Alternatively, the vehicle may be a heavy-duty diesel vehicle (HDV), such as a diesel vehicle having a gross weight of >8,500 pounds (US lbs), as defined in US legislation.

When the oxidation catalyst is used as a passive NOₓ absorber (PNA), the oxidation catalyst absorbs or stores NOₓ from the exhaust gas at a first temperature range and releases NOₓ at a second temperature range, wherein the second temperature range is higher the first temperature range (e.g. the midpoint of the second temperature range is higher than the midpoint of the first temperature range). It is preferable that the second temperature range does not overlap with the first temperature range. There may be a gap between the upper limit of first temperature range and the lower limit of the second temperature range.

Typically, the oxidation catalyst releases NOₓ at a temperature greater than 200° C. This is the lower limit of the second temperature range. Preferably, the oxidation catalyst releases NOₓ at a temperature of 220° C. or above, such as 230° C. or above, 240° C. or above, 250° C. or above, or 260° C. or above.

The oxidation catalyst absorbs or stores NOₓ at a temperature of 200° C. or less. This is the upper limit of the first temperature range. Preferably, the oxidation catalyst absorbs or stores NOₓ at a temperature of 195° C. or less, such as 190° C. or less, 185° C. or less, 180° C. or less, or 175° C. or less.

The oxidation catalyst may preferentially absorb or store nitric oxide (NO). Thus, any reference to absorbing, storing or releasing NOₓ in this context may refer absorbing, storing or releasing nitric oxide (NO). Preferential absorption or storage of NO will decrease the ratio of NO:NO₂ in the exhaust gas.

### Definitions

The labels “first”, “second” and “third” as used herein, particularly in the context of a “first region”, a “second region”, a “third region”, a “second support material” or a “third support material”, are used herein to distinguish the feature (i.e. the region or support material) from another feature of the same type. The label does not place any limitation on the number or presence of those features. Thus, for example, any reference to a “third support material” does not require the presence of both a “first support material” and a “second support material”.

The term “region” as used herein refers to an area on a substrate, typically obtained by drying and/or calcining a washcoat. A “region” can, for example, be disposed or supported on a substrate as a “layer” or a “zone”. The area or arrangement on a substrate is generally controlled during the process of applying the washcoat to the substrate. The “region” typically has distinct boundaries or edges (i.e. it is possible to distinguish one region from another region using conventional analytical techniques).

Typically, the “region” has a substantially uniform length. The reference to a “substantially uniform length” in this context refers to a length that does not deviate (e.g. the difference between the maximum and minimum length) by more than 10%, preferably does not deviate by more than 5%, more preferably does not deviate by more than 1%, from its mean value.

Any reference to a “zone disposed at an inlet end of the substrate” used herein refers to a zone disposed or supported on a substrate where the zone is nearer to an inlet end of the substrate than the zone is to an outlet end of the substrate. Thus, the midpoint of the zone (i.e. at half its length) is nearer to the inlet end of the substrate than the midpoint is to the outlet end of the substrate. Similarly, any reference to a “zone disposed at an outlet end of the substrate” used herein refers to a zone disposed or supported on a substrate where the zone is nearer to an outlet end of the substrate than the zone is to an inlet end of the substrate. Thus, the midpoint of the zone (i.e. at half its length) is nearer to the outlet end of the substrate than the midpoint is to the inlet end of the substrate.

When the substrate is a wall-flow filter, then generally any reference to a “zone disposed at an inlet end of the substrate” refers to a zone disposed or supported on the substrate that is:
(a) nearer to an inlet end (e.g. open end) of an inlet channel of the substrate than the zone is to a closed end (e.g. blocked or plugged end) of the inlet channel, and/or
(b) nearer to a closed end (e.g. blocked or plugged end) of an outlet channel of the substrate than the zone is to an outlet end (e.g. open end) of the outlet channel. Thus, the midpoint of the zone (i.e. at half its length) is (a) nearer to an inlet end of an inlet channel of the substrate than the midpoint is to the closed end of the inlet channel, and/or (b) nearer to a closed end of an outlet channel of the substrate than the midpoint is to an outlet end of the outlet channel.

Similarly, any reference to a “zone disposed at an outlet end of the substrate” when the substrate is a wall-flow filter refers to a zone disposed or supported on the substrate that is:
(a) nearer to an outlet end (e.g. an open end) of an outlet channel of the substrate than the zone is to a closed end (e.g. blocked or plugged) of the outlet channel, and/or
(b) nearer to a closed end (e.g. blocked or plugged end) of an inlet channel of the substrate than it is to an inlet end (e.g. an open end) of the inlet channel.

Thus, the midpoint of the zone (i.e. at half its length) is (a) nearer to an outlet end of an outlet channel of the substrate than the midpoint is to the closed end of the outlet channel, and/or (b) nearer to a closed end of an inlet channel of the substrate than the midpoint is to an inlet end of the inlet channel.

A zone may satisfy both (a) and (b) when the washcoat is present in the wall of the wall-flow filter (i.e. the zone is in-wall).

The term “adsorber” as used herein, particularly in the context of a NOₓ adsorber, should not be construed as being limited to the storage or trapping of a chemical entity (e.g. NOₓ) only by means of adsorption. The term “adsorber” used herein is synonymous with “absorber”.

The term “mixed oxide” as used herein generally refers to a mixture of oxides in a single phase, as is conventionally known in the art. The term “composite oxide” as used herein generally refers to a composition of oxides having more than one phase, as is conventionally known in the art.

Any reference to zones that do not “substantially overlap” as used herein refers an overlap (i.e. between the ends of neighbouring zones on a substrate) of less than 10% of the length of the substrate, preferably less 7.5% of the length of the substrate, more preferably less than 5% of the length of the substrate, particularly less than 2.5% of the length of the substrate, even more preferably less than 1% of the length of the substrate, and most preferably there is no overlap.

The expression “consist essentially” as used herein limits the scope of a feature to include the specified materials, and any other materials or steps that do not materially affect the basic characteristics of that feature, such as for example minor impurities. The expression “consist essentially of” embraces the expression “consisting of”.

The expression “substantially free of” as used herein with reference to a material, typically in the context of the content of a washcoat region, a layer or a zone, means that the material in a minor amount, such as 5% by weight, preferably 2% by weight, more preferably 1% by weight. The expression “substantially free of” embraces the expression “does not comprise”.

Any reference to an amount of dopant, particularly a total amount, expressed as a % by weight as used herein refers to the weight of the support material or the refractory oxide thereof.

### EXAMPLES

The invention will now be illustrated by the following non-limiting examples.

### Example 1 (Reference)

Pd nitrate was added to a slurry of a small pore zeolite with CHA structure and was stirred. Alumina binder was added and then the slurry was applied to a cordierite flow through monolith having 400 cells per square inch using established coating techniques to form a layer. The coating was dried and calcined at 500° C. A coating comprising a Pd-exchanged zeolite was obtained. The Pd loading of this coating was 80 g ft⁻³.

A second slurry was prepared using a Mn-doped silica-alumina powder milled to a d₉₀<20 micron. Soluble platinum salt was added followed by beta zeolite, such that the slurry comprised 75% Mn-doped silica-alumina and 25% zeolite by mass. The slurry was then stirred to homogenise. The resulting washcoat was applied to the channels at the inlet end of the flow through monolith using established coating techniques to form a zone. The part was then dried. The Pt loading of this coating was 68 g ft⁻³.

A third slurry was prepared using a Mn-doped silica-alumina powder milled to a d₉₀<20 micron. Soluble platinum salt was added and the mixture was stirred to homogenise. The slurry was applied to the channels at outlet end of the flow through monolith using established coating techniques to form a zone. The coating was then dried and calcined at 500° C. The Pt loading of this coating was 68 g ft⁻³.

### Example 2

Pd nitrate was added to a slurry of a small pore zeolite with CHA structure and was stirred. Alumina binder was added and then the slurry was applied to a cordierite flow through monolith having 400 cells per square inch using established coating techniques to form a layer. The coating was dried and calcined at 500° C. A coating comprising a Pd-exchanged zeolite was obtained. The Pd loading of this coating was 80 g ft⁻³.

A preformed powder of Au and Pd was prepared by slurrying alumina powder in water and heating to 55-60° C. The pH of the slurry was raised to 8.5 by addition of K₂CO₃ solution. In a separate vessel, a solution of HAuCl₄ and a solution of palladium nitrate were mixed. The combined Au and Pd solutions were added to the alumina slurry over 15 minutes. During the addition the pH was maintained between 6 and 7 by the addition of K₂CO₃. After 1 hour the stirring was stopped and the powder allowed to settle to the bottom of the vessel. Most of the supernatant (containing some soluble Pd and Au species) was removed from the vessel by decanting. Hydrazine solution (1%) was then added to the vessel under stirring along with additional water. The slurry was stirred for 15 minutes then filtered and washed with water.

The preformed Au/Pd on alumina powder was slurried in water and milled to a d₉₀<20 micron. Beta zeolite was added and alumina binder such that the slurry comprised 69% Au/Pd on alumina, 17% beta zeolite, 14% alumina binder. The slurry was stirred to homogenise and then applied to the inlet channels of the flow through monolith using established coating techniques to form a zone. The coating was dried and calcined at 500° C. The Au loading of this coating was 43 g ft⁻³ and the Pd loading of this coating was 35 g ft⁻³.

A third slurry was prepared using a Mn-doped silica-alumina powder milled to a d₉₀<20 micron. Soluble platinum salt was added and the mixture was stirred to homogenise. The slurry was applied to the channels at outlet end of the flow through monolith using established coating techniques to form a zone. The coating was then dried and calcined at 500° C. The Pt loading of this coating was 68 g ft⁻³.

### Experimental Results

The catalysts of Examples 1 and 2 were hydrothermally aged at 750° C. for 15 hours with 10% water. They were performance tested over a simulated MVEG-B emissions cycle, also referred to as the New Emissions Drive Cycle (NEDC). The catalyst was fitted in a position close coupled to the turbo charger on a 2.0 litre bench mounted diesel engine. Emissions were measured pre- and post-catalyst. The NOₓ adsorbing performance of each catalyst was determined as the difference between the cumulative NOₓ emission pre-catalyst compared with the cumulative NOₓ emission post-catalyst. The difference between the pre- and post-catalyst cumulative NOₓ emissions is attributed to NOₓ adsorbed by the catalyst. CO and HC oxidation performance is calculated as the cumulative conversion efficiency over the complete test cycle. N₂O emissions are measured by Fourier Transform Infra-Red spectroscopy (FTIR) and reported as the cumulative emission post-catalyst. This measurement also includes any N₂O emissions produced from the engine during the combustion process.

Table 1 shows the NOₓ adsorbing performance of the catalysts of Examples 1 and 2 at 400 seconds into the MVEG-B test.

TABLE 1

| Example No. | NOₓ adsorbed at 400 seconds (g) |
|---|---|
| 1 | 0.37 |
| 2 | 0.36 |

Table 2 shows the CO and HC oxidation conversion performance of the catalysts of Examples 1 and 2 over a complete MVEG-B cycle.

TABLE 2

| Example No. | CO conversion (%) | HC conversion (%) |
|---|---|---|
| 1 | 64 | 75 |
| 2 | 66 | 74 |

Table 3 shows the cumulative N₂O emissions post-catalyst for the catalysts of Examples 1 and 2 over a complete MVEG-B cycle.

TABLE 3

| Example No. | N₂O emission (mg) |
|---|---|
| 1 | 107 |
| 2 | 82 |

The results in Table 1 show that Examples 1 and 2 adsorb similar amounts of NOₓ. The results in Table 2 show that Examples 1 and 2 convert similar percentages of CO and HC. The results in Table 3 show that Example 2 produces less N₂O than Example 1. Example 2 comprises Pd and Au in a second region and is effective for lower N₂O emissions.

For the avoidance of any doubt, the entire content of any and all documents cited herein is incorporated by reference into the present application.

1. An oxidation catalyst for treating an exhaust gas from a diesel engine, which oxidation catalyst comprises:
a first region for adsorbing NOₓ, wherein the first region comprises a molecular sieve catalyst, wherein the molecular sieve catalyst comprises a noble metal and a molecular sieve;
a second region for oxidising carbon monoxide (CO) and/or hydrocarbons (HCs), wherein the second region comprises palladium (Pd), gold (Au) and a support material; and
a substrate having an inlet end and an outlet end.

2. An oxidation catalyst according to claim 1, wherein the noble metal comprises palladium.

3. An oxidation catalyst according to claim 1, wherein the molecular sieve is selected from a small pore molecular sieve, a medium pore molecular sieve and a large pore molecular sieve.

4. An oxidation catalyst according to claim 1, wherein the molecular sieve is a small pore molecular sieve having a Framework Type selected from the group consisting of ACO, AEI, AEN, AFN, AFT, AFX, ANA, APC, APD, ATT, CDO, CHA, DDR, DFT, EAB, EDI, EPI, ERI, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and a mixture or intergrowth of any two or more thereof.

5. An oxidation catalyst according to claim 1, wherein the molecular sieve has an aluminosilicate framework and a silica to alumina molar ratio of 10 to 200.

6. An oxidation catalyst according to claim 1, wherein the second region comprises a palladium-gold alloy.

7. An oxidation catalyst according to claim 1, wherein the second region has a ratio by mass of palladium (Pd) to gold (Au) of 9:1 to 1:9.

8. An oxidation catalyst according to claim 1, wherein the support material comprises a refractory oxide selected from the group consisting of alumina, silica, titania, zirconia, ceria and a mixed or composite oxide of two or more thereof.

9. An oxidation catalyst according to claim 1, wherein the first region is arranged to contact the exhaust gas at the outlet end of the substrate and after contact of the exhaust gas with the second region.

10. An oxidation catalyst according to claim 9, wherein at least one of:
(a) the first region is a first zone disposed at an outlet end of the substrate and the second region is a second zone disposed at an inlet end of the substrate;
(b) the second region is a second layer and the first region is a first zone, and wherein the first zone is disposed on the second layer at an outlet end of the substrate;
(c) the second region is a second zone and the first region is a first layer, and wherein the second zone is disposed on the first layer at an inlet end of the substrate; or
(d) the second region is a second layer and the first region is a first layer, and wherein the second layer is disposed on the first layer.

11. An oxidation catalyst according to claim 1, wherein the second region is arranged to contact the exhaust gas at or near the outlet end of the substrate and after contact of the exhaust gas with the first region.

12. An oxidation catalyst according to claim 11, wherein at least one of:
(a) the second region is a second zone disposed at an outlet end of the substrate and the first region is a first zone disposed at an inlet end of the substrate;
(b) the first region is a first layer and the second region is a second zone, and wherein the second zone is disposed on the first layer at an outlet end of the substrate; or
(c) the first region is a first layer and the second region is a second layer, and wherein the second layer is disposed on the first layer.

13. An oxidation catalyst according to claim 1 further comprising a third region, wherein the third region comprises platinum, a support material and optionally manganese or an oxide thereof.

14. An oxidation catalyst according to claim 13, wherein at least one of:
(a) the first region is a first zone disposed at an outlet end of the substrate and the second region is a second zone disposed at an inlet end of the substrate, and wherein the first zone is disposed on the third region and the second zone is disposed on the third region;
(b) the second region is a second layer and the first region is a first zone, and wherein the first zone is disposed on the second layer at an outlet end of the substrate, and the second layer is disposed on the third region;
(c) the second region is a second layer and the first region is a first layer, and wherein the second layer is disposed on the first layer, and the first layer is disposed on the third region;
(d) the second region is a second zone disposed at an outlet end of the substrate and the first region is a first zone disposed at an inlet end of the substrate, and wherein the first zone is disposed on the third region and the second zone is disposed on the third region;
(e) the first region is a first layer and the second region is a second zone, and wherein the second zone is disposed on the first layer at an outlet end of the substrate, and the first layer is disposed on the third region; or
(f) the first region is a first layer and the second region is a second layer, and wherein the first layer is disposed on the second layer, and the second layer is disposed on the third region.

15. An oxidation catalyst according to claim 1, wherein the substrate is a through-flow substrate.

16. An exhaust system comprising an oxidation catalyst as defined in claim 1.
